(19) United States
(12) Patent Application Publication
(10) Pub. No.: US 2005/0195892 A1
(43) Pub. Date: Sep. 8, 2005

(54) Training and updating for multiple input-output wireline communications

(75) Inventors: Georgios Ginis, Mountain View, CA (US); Raghuraman Mariappan, Mountain View, CA (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/053,634

(22) Filed: Feb. 8, 2005

Related U.S. Application Data
(60) Provisional application No. 60/550,506, filed on Mar. 5, 2004.

(51) Int. Cl. H04B 1/38

(52) U.S. Cl. 375/222

(57) ABSTRACT

The present invention provides a crosstalk mitigator for use in vectoring a digital subscriber line (DSL) system having initial crosstalk interference. In one embodiment, the crosstalk mitigator includes a crosstalk parameter estimation portion configured to determine crosstalk parameters associated with the initial crosstalk interference, and a mitigator initialization portion coupled to the crosstalk parameter estimation portion and configured to train the DSL system to provide a mitigated crosstalk based on the crosstalk parameters prior to a data transmission mode. In an alternative embodiment, the capability to detect a change in the mitigated crosstalk during the data transmission mode and update the crosstalk parameters to rectify the change in the mitigated crosstalk is provided.

### CROSS-REFERENCE TO PROVISIONAL APPLICATION

This application claims the benefit of U.S. Provisional Application No. 60/550,506 entitled “Training and Updating for Multiple-Input-Output Wireline Communications” to Georgios Ginis, et al., filed on Mar. 5, 2004, which is incorporated herein by reference in its entirety.

### TECHNICAL FIELD OF THE INVENTION

The present invention is directed, in general, to communication systems and, more specifically, to a crosstalk mitigator, a method of crosstalk mitigation and a digital subscriber line (DSL) system employing the mitigator or the method.

### BACKGROUND OF THE INVENTION

High-bandwidth data, such as multimedia and video, may be transported within a communication network using a digital subscriber line (DSL) system. The general term DSL is used to cover a variety of similar system implementations, which have the ability to deliver high-bandwidth data rates to dispersed locations with relatively small changes in existing communication infrastructure. DSL systems typically employ a combination of fiber optic and existing twisted-pair telephone lines to transmit and receive data. Transmission distance over the twisted-pair telephone lines is inversely proportional to data rate and typically ranges from about 1000 feet for higher data rates up to several miles for lower ones.

A DSL system employs a transmission unit, having both transmit and receive capability, at a central office location associated with a service provider (central office equipment) and a transmission unit at a remote end location associated with a service subscriber (customer premises equipment). Discrete multitone modulation (DMT), which is a multicarrier modulation technique using discrete Fourier transforms to create and demodulate each individual carrier, is employed for data transport in most DSL systems.

Crosstalk is a major impairment in DSL telecommunication networks, since it degrades both upstream and downstream data communications thereby lowering effective data rates needed to provide reliable data communication. Crosstalk occurs between different DSL twisted-pair transmission lines when the signal on one twisted-pair cross-couples into another twisted-pair due to their close proximity. The crosstalk originates from generally two sources classified as in-domain crosstalk signals and out-of-domain crosstalk signals. In-domain crosstalk signals originate within a DSL system, which includes multiple DSL pairs. Correspondingly, out-of-domain crosstalk signals originate outside a DSL system. Additionally, crosstalk may be classified as near-end crosstalk (NEXT) or far-end crosstalk (FEXT). NEXT occurs between signals originating from multiple transmission units at the same end of a DSL pair. Alternatively, FEXT occurs between signals originating from multiple transmission units at the opposite end of a DSL pair.

In order to reduce performance loss arising from crosstalk, DSL systems are typically designed under worst-case crosstalk scenarios that lead to overly conservative DSL deployments. Vectoring for a DSL system employs a set of principles utilizing signal processing techniques to suppress or cancel crosstalk associated with the DSL system. Vectoring techniques provide some relief from designs employing worst-case crosstalk scenarios allowing less overly conservative DSL deployments.

However, current vectoring techniques target specific and often singular crosstalk sources independently. Additionally, parameters involving a complex combination of NEXT and FEXT from in-domain and out-of-domain sources are often assummed. Also, current vectoring techniques use a crosstalk suppression or cancellation that is assumed to be unchanging and stationary over a period time. However the crosstalk environment typically drifts over time, which adds another degree of design and performance conservatism associated with current vectoring deployments.

Accordingly, what is needed in the art is a better way to reduce crosstalk interference in a DSL system produced from multiple crosstalk sources and that may change during different modes of system operation.

### SUMMARY OF THE INVENTION

To address the above-discussed deficiencies of the prior art, the present invention provides a crosstalk mitigator for use in vectoring a digital subscriber line (DSL) system having initial crosstalk interference. In one embodiment, the crosstalk mitigator includes a crosstalk parameter estimation portion configured to determine crosstalk parameters associated with the initial crosstalk interference, and a mitigator initialization portion coupled to the crosstalk parameter estimation portion and configured to train the DSL system to provide a mitigated crosstalk based on the crosstalk parameters prior to a data transmission mode.

In another aspect, the present invention provides a method of crosstalk mitigation for use in vectoring a digital subscriber line (DSL) system having initial crosstalk interference. The method includes determining crosstalk parameters associated with the initial crosstalk interference, and training the DSL system to provide a mitigated crosstalk based on the crosstalk parameters prior to a data transmission mode.

The present invention also provides, in yet another aspect, a digital subscriber line (DSL) system. The DSL system employs first and second DSL transmission loops having first and second transmission lines that experience initial crosstalk interference. The DSL system includes a crosstalk mitigator, coupled to and for use in vectoring the first and second DSL transmission loops, having a crosstalk parameter estimation portion that determines crosstalk parameters associated with the initial crosstalk interference. The crosstalk mitigator also includes a mitigator initialization portion, coupled to the crosstalk parameter estimation portion, that trains the DSL system to provide a mitigated crosstalk based on the crosstalk parameters prior to a data transmission mode.

In alternative embodiments, the crosstalk mitigator and the method of crosstalk mitigation include the capability to detect a change in the mitigated crosstalk during the data transmission mode and update the crosstalk parameters to rectify the change in the mitigated crosstalk.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following descriptions taken in conjunction with the accompanying drawings, in which:

FIG. 1 illustrates a system diagram of an embodiment of a DSL system employing crosstalk mitigation constructed in accordance with the principles of the present invention;

FIG. 2 illustrates a portion of a DSL loop that may be employed in a DSL system as was discussed with respect to FIG. 1; and

FIG. 3 illustrates a flow diagram of an embodiment of a method of crosstalk mitigation carried out in accordance with the principles of the present invention.

### DETAILED DESCRIPTION

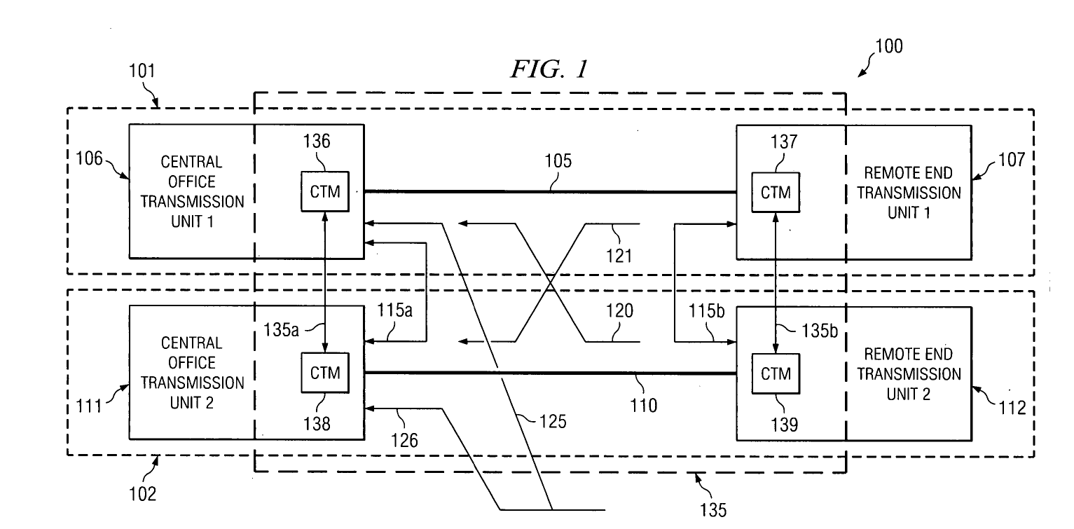

Referring initially to FIG. 1, illustrated is a system diagram of an embodiment of a DSL system, generally designated 100, employing crosstalk mitigation constructed in accordance with the principles of the present invention. The DSL system 100 includes first and second DSL transmission loops 101, 102 employing first and second transmission lines 105, 110 that experience initial crosstalk interference. The first transmission loop 101 includes a first central office transmission unit (COTU) 106 and a first remote end transmission unit (RETU) 107 coupled to the first transmission line 105. The second transmission loop 102 includes a second COTU 111 and a second RETU 112 coupled to the second transmission line 110. In the illustrated embodiment, the DSL system employs discrete multitone (DMT) modulation. However, alternative embodiments may employ QAM and PAM, and the principles of the present invention may also be applied to other twisted-pair systems, such as Ethernet over copper. Of course, alternative embodiments of the present invention may also employ more than two transmission lines.

The initial crosstalk interference includes in-domain, near-end crosstalk (ID-NEXT) 115a, 115b and first and second in-domain, far-end crosstalk (ID-FEXT) 120, 121. Additionally, the initial crosstalk interference includes first and second out-of-domain, far-end crosstalk (OOD-NEXT/FEXT) 125, 126. The first and second DSL transmission loops 101, 102 also include a crosstalk mitigator 135 having first, second, third and fourth crosstalk mitigation sections (CTM) 136, 137, 138, 139, which are coupled to and employed for vectoring the first and second DSL transmission loops 101, 102. Additionally, the first and third CTM 136, 138 employ a mutual coupling 135a, and the second and fourth CTM 137, 139 employ another mutual coupling 135b that allow communication between the respective sections. In alternative embodiments, the crosstalk mitigation sections may occur only at the remote end (CTM 137, 139) or at the central office end (CTM 136, 138). FIG. 1 shows the crosstalk parameters affecting upstream transmission toward the central office. However, the case for downstream transmission toward the remote end is very similar and extension to more transmission loops or transmission lines is also straightforward.

Each of the crosstalk mitigation sections 136-139 includes a crosstalk parameter estimation portion that determines crosstalk parameters associated with the initial crosstalk interference, and a mitigator initialization portion, coupled to the crosstalk parameter estimation portion, that trains the DSL system to provide a mitigated crosstalk based on the crosstalk parameters prior to a data transmission mode, which may also be denoted as “showtime”. In the illustrated embodiment, the crosstalk mitigation sections 136-139 also include a showtime updating and crosstalk mitigation portion that detects a change in the mitigated crosstalk during the data transmission mode and updates the crosstalk parameters to rectify the change in the mitigated crosstalk. In an alternative embodiment, the crosstalk parameter estimation portion and the mitigator initialization portion may be employed as separate units as appropriately dictated by a particular application.

The crosstalk mitigator 135 employs at least one of several approaches towards achieving crosstalk reduction. These approaches include suppression of NEXT/FEXT from out-of-domain transmission lines (OOD-NEXT/FEXT 125, 126), cancellation of NEXT from in-domain transmission lines (ID-NEXT 115) and cancellation of FEXT from in-domain transmission lines (ID-FEXT 120, 121). It may be noted that crosstalk parameter estimation always takes place at a receiver based on the received samples, and possibly using knowledge of the transmitted training sequences or of other known transmitted data.

It is assumed that synchronization is achieved among all subsystems associated with the DSL system 100. For example, this may be achieved by using cyclic prefix, cyclic suffix and timing advance techniques. Then, a channel model for vectoring the central office end of the DSL system 100 can be mathematically expressed on a per-tone basis as shown in equation (1) below.

$$[ \begin{matrix}{Y}_{1} \\ {Y}_{2}\end{matrix} ] = [ \begin{matrix}{H}_{11} & {H}_{12} \\ {H}_{21} & {H}_{22}\end{matrix} ] [ \begin{matrix}{X}_{1} \\ {X}_{2}\end{matrix} ] + [ \begin{matrix}{H}_{11}^{N} & {H}_{12}^{N} \\ {H}_{21}^{N} & {H}_{22}^{N}\end{matrix} ] [ \begin{matrix}{X}_{1}^{N} \\ {X}_{2}^{N}\end{matrix} ] + [ \begin{matrix}{N}_{1} \\ {N}_{2}\end{matrix} ] . \qquad ( 1 )$$

The covariance matrix of the noise vector is

$$\begin{matrix}{R}_{NN} = [ \begin{matrix}{σ}_{1}^{2} & {σ}_{12} \\ {σ}_{21} & {σ}_{2}^{2}\end{matrix} ] , \\ and & ( 2 ) \\ {σ}_{12} = conj ( {σ}_{21} ) , & ( 3 )\end{matrix}$$

where the parameters presented in equations (1), (2) and (3) are discussed below, and the channel model is assumed to refer to a specific tone.

Non-crosstalk related terms are presented first. First and second insertion loss transfer functions H₁₁, H₂₂ are the frequency responses for a specified tone on the first and second transmission lines 105, 110, respectively. These quantities may be estimated using either a periodic training signal (e.g., REVERB) or a non-periodic training signal (e.g., MEDLEY).

First and second echo path transfer functions H₁₁^{N}, H₂₂^{N} are frequency responses for a specified tone on the first and second transmission lines 105, 110, respectively. They may be estimated during echo training using a vendor-proprietary training signal. These quantities are assumed to equal zero in the analysis presented.

First and second noise variances σ₁², σ₂² are associated with receiver inputs coupled to the first and second transmission lines 105, 110, respectively. These quantities may be estimated using either a periodic or a non-periodic training signal.

Crosstalk parameters include first and second far-end crosstalk coupling transfer functions (i.e., initialization far-end crosstalk coefficients) H₂₁, H₂₁, which are frequency responses for a specified tone associated with the far-end crosstalk. The first transfer function H₁₂ represents the FEXT coupling from the second transmission line 110 onto the first transmission line 105 (ID-FEXT 120). Correspondingly, the second transfer function H₂₁ represents the FEXT coupling from the first transmission line 105 onto the second transmission line 110 (ID-FEXT 121). These two quantities are not necessarily equal.

First and second near-end crosstalk coupling transfer functions (i.e., initialization near-end crosstalk coefficients) H₁₂^{N}, H₂₁^{N} are frequency responses for a specified tone associated with near-end crosstalk coupling. The first transfer function H₁₂^{N} represents the NEXT coupling from the second transmission line 110 onto the first transmission line 105. Correspondingly, the second transfer function H₂₁^{N} represents the NEXT coupling from the first transmission line 105 onto the second transmission line 110. These two couplings are shown in FIG. 1 as ID-NEXT 115 although they are not necessarily equal.

First and second noise correlations (i.e., initialization noise correlation crosstalk parameters) σ₁₂, σ₂₁ are the correlations between the noises (OOD-NEXT/FEXT 125, 126) at the input of first and second receivers corresponding to first and second COTUs 106, 111. These two quantities are conjugates and therefore only one needs to be estimated. Each of the approaches towards crosstalk reduction requires knowledge of these parameters. The correspondence between each type of crosstalk and its mitigating parameter that needs to be estimated is summarized in Table 1, below.

TABLE 1
CROSSTALK RELATIONSHIPS

| Crosstalk Quantity | Crosstalk Parameter |
|---|---|
| Suppression of NEXT/FEXT from | σ₁₂ (noise correlation) |
| out-of-domain lines | |
| Cancellation of NEXT from | H₁₂^{N}, H₂₁^{N} (NEXT coupling) |
| in-domain lines | |
| Cancellation of FEXT from | H₁₂, H₂₁ (FEXT coupling) |
| in-domain lines | |

For cancellation of FEXT from in-domain lines, and specifically for the case of one-sided coordination (typically central office colocation), the estimated parameters H₁₂, H₂₁ may need to be communicated from the downstream receivers to the downstream vector-transmitter. Alternatively, some reduced set of functionally equivalent parameters needs to be communicated. Such communication is not required for all of the approaches presented.

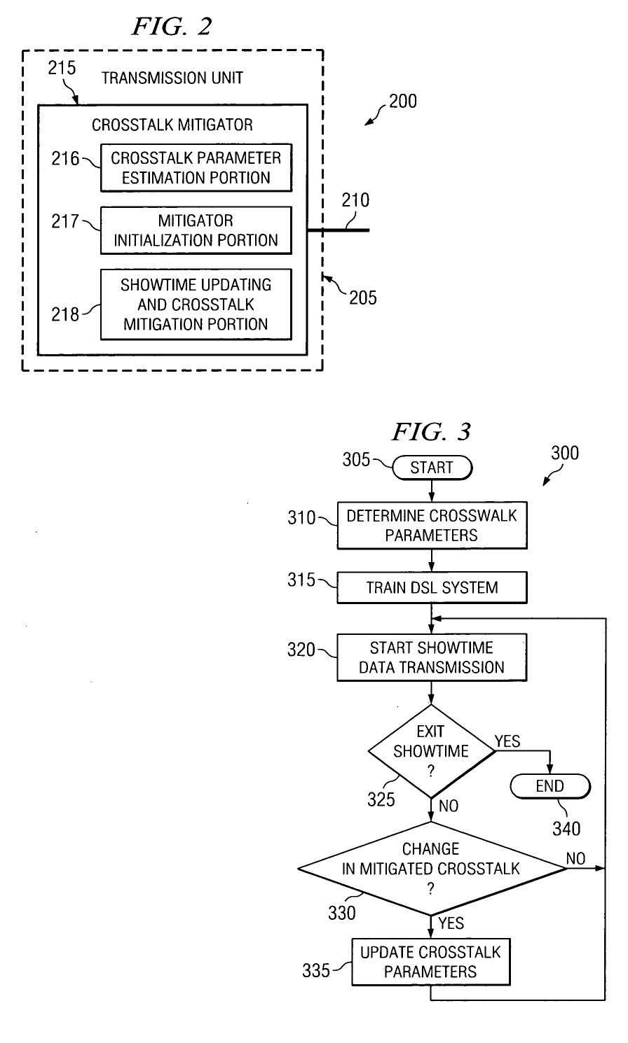

Turning now to FIG. 2, illustrated is a portion of a DSL loop, generally designated 200, that may be employed in a DSL system as was discussed with respect to FIG. 1. The DSL loop portion 200 includes a transmission unit 205, a transmission line 210 that experiences crosstalk and a crosstalk mitigator 215. The crosstalk mitigator 215 includes a crosstalk parameter estimation portion 216, a mitigator initialization portion 217 and a showtime updating and crosstalk mitigation portion 218.

The crosstalk parameter estimation portion 216 is configured to determine crosstalk parameters associated with the initial crosstalk interference, and the mitigator initialization portion 217, which is coupled to the crosstalk parameter estimation portion 216, is configured to train the DSL loop 200 to provide a mitigated crosstalk based on the crosstalk parameters. This training is accomplished prior to a data transmission mode for the DSL loop 200. The showtime updating and crosstalk mitigation portion 218 is configured to detect a change in the mitigated crosstalk during the data transmission mode and update the crosstalk parameters to rectify the chance in the mitigated crosstalk.

The crosstalk parameter estimation portion 216 may advantageously employ orthogonal signals to determine the crosstalk parameters such as those that were discussed with respect to FIG. 1. The use of orthogonal signals greatly simplifies the required computations to obtain the needed crosstalk parameters. For two transmission lines, orthogonality may be defined as shown below in equation (4).
E(X₁X₂*)=0, (4)
where X₁ and X₂ are the transmitted symbols on a specific tone, and E( ) indicates expectation. In practice, expectation can be replaced by a large sum over multiple symbols.

Three basic approaches may be employed to achieve orthogonality:
1. Transmit only on one transmission line at a time,
2. Use pseudo-random sequences having a different seed or different polynomial on each transmission line, and
3. Use the same pseudo-random sequences on all lines but apply a different signature on each line.

In the first case, signal orthogonality may be achieved if only one transmission line is transmitting during mutually exclusive time periods on each tone. That is, a transmission may be orthogonal if two lines are transmitting at the same time, but not on the same tone. This, of course, means that transmissions on other transmission lines during this time period correspond to nulls or zero transmissions. The symbols on the transmitting line can be formed using the same methods currently employed in DSL (e.g. REVERB, MEDLEY, etc).

In the second case, a pseudo-random sequence is generated, which is used to form the symbols transmitted on each transmission line. However, if the generator polynomial or the seed (i.e., starting point) is appropriately chosen, then the symbols formed by the sequences can be made to be orthogonal or substantially orthogonal.

In the third case, the same pseudo-random sequence is used on all transmission lines. However, the symbols of different transmission lines are made orthogonal to each other by applying an appropriate signature, which is similar to what is employed in code division multiple access (CDMA) communication systems. It may also be noted that in the case of non-colocated receivers, the parameters that identify the seed, the generator polynomial or the signature for all transmission lines is available to the receiver associated with the transmission unit 205 in order to properly estimate the needed crosstalk parameters.

The mitigator initialization portion 217 provides an estimation of the crosstalk parameters needed for suppression of NEXT/FEXT from out-of-domain transmission lines and for cancellation of FEXT from in-domain transmission lines. The principles of estimation of crosstalk parameters for cancellation of NEXT from in-domain transmission lines are similar to those of echo cancellation, which are understood by one skilled in the pertinent art. In the following it is assumed that synchronization among all transmission lines included in—a vectored system has been achieved and that signal orthogonality is also employed. Then,
H₁₂=E(Y₁X₂*)/E(X₂X₂*), (5)
and the operation at a second receiver is
H₂₁=E(Y₂X₁*)/E(X₁X₁*), (6)
In equations (5) and (6), the expectation operator E( ) may be interpreted as averaging.

The crosstalk parameter needed for NEXT/FEXT suppression may be estimated by computing the sample correlation of the received signals Y₁ and Y₂ as denoted in equation (7).
Y₁Y₂*=H₁₁H₂₁*X₁X₁*+H₁₂H₂₂*X₂X₂*+H₁₁^{N}H₂₁^{N}*X₁^{N}X₁^{N}*+H₁₂^{N}H₂₂^{N}*X₂^{N}X₂^{N}*+N₁N₂* (7)
In equation (7), some terms have been omitted due to signal orthogonality. It also follows that the noise correlation σ₁₂ may be estimated as shown in equation (8).

$$\begin{matrix}{σ}_{12} = \frac{1}{{N}_{frames} - 1} {\sum }_{i = 1}^{{N}_{frames}} {N}_{1} {N}_{2}^{*} \\ = \frac{1}{{N}_{frames} - 1} {\sum }_{i = 1}^{{N}_{frames}} {Y}_{1} {Y}_{2}^{*} - {H}_{11} {H}_{21}^{*} {E}_{1} - {H}_{12} {H}_{22}^{*} {E}_{2} - \\ {H}_{11}^{N} {H}_{21}^{N *} {E}_{1}^{N} - {H}_{12}^{N} {H}_{22}^{N *} {E}_{2}^{N} ,\end{matrix} \qquad ( 8 )$$

where sample indices have been omitted and Eᵢ, Eᵢ^{N} represent estimated signal energies. Equation (8) assumes that the signals on different transmission lines are uncorrelated.

It may be noted that equation (8) requires knowledge of certain channel parameters. The number of parameters that need to be computed may be reduced by allowing signal transmission in only one direction during this training mode. The computation is also simplified by allowing no transmission during this training (i.e., during the initial quiet periods of the modems). It may also be noted that subtraction operations in equation (8) can suffer from precision issues, since the quantities to be estimated may be very small.

Although initialization training provides knowledge of the parameters needed to accomplish vectoring, these parameters may drift over time, and thus degrade the performance of the vectoring algorithms. In order to prevent this, the showtime updating and crosstalk mitigation portion 218 may be employed to update these parameters. If coordination is possible on the receiver side, then updating of the parameters associated with FEXT cancellation may be obtained using decision-directed algorithms, which can be viewed as generalizations of the FEQ adaptation algorithms. If noise may be neglected:

$$[ \begin{matrix}{Y}_{1}^{( 1 )} & {Y}_{2}^{( 1 )} \\ {Y}_{1}^{( 2 )} & {Y}_{2}^{( 2 )}\end{matrix} ] = [ \begin{matrix}{X}_{1}^{( 1 )} & {X}_{2}^{( 1 )} \\ {X}_{1}^{( 2 )} & {X}_{2}^{( 2 )}\end{matrix} ] [ \begin{matrix}{H}_{11} & {H}_{12} \\ {H}_{21} & {H}_{22}\end{matrix} ] , \qquad ( 9 )$$

where the superscript in parenthesis indicates a DMT symbol index. Therefore, using received samples from two consecutive DMT symbols and the decoded data symbols, the FEXT coupling parameters can be obtained by matrix inversion of equation (9). Averaging over multiple such calculations may be needed to eliminate the effects of noise.

The existence of a synchronization symbol (e.g., as in ADSL, where it is repeated every 69 frames) allows an alternative approach, which does not require co-location. If the synchronization symbols on different transmission lines are orthogonal, then

H₁₂=E(Y₁X₂*)/E(X₂X₂*), (10a)
and
H₂₁=E(Y₂X₁*)/E(X₁X₁*) (10b)
where the expectation E( ) is interpreted as averaging over multiple synchronization symbols.

The crosstalk parameter needed for NEXT/FEXT suppression may be updated during showtime by using the slicer or decoder errors corresponding to first and second transmission lines. Alternatively, the synchronization symbol may be utilized. By subtracting the received samples during consecutive synchronization symbols, a noise difference may be obtained by employing equation (11).

$$\begin{matrix}[ \begin{matrix}{D}_{1} \\ {D}_{2}\end{matrix} ] = [ \begin{matrix}{Y}_{1}^{( 1 )} & - {Y}_{1}^{( 2 )} \\ {Y}_{2}^{( 1 )} & - {Y}_{2}^{( 2 )}\end{matrix} ] = [ \begin{matrix}{N}_{1}^{( 1 )} & - {N}_{1}^{( 2 )} \\ {N}_{2}^{( 1 )} & - {N}_{2}^{( 2 )}\end{matrix} ] . \\ Then , & ( 11 ) \\ E ( {D}_{1} {D}_{2}^{*} ) = 2 {σ}_{12}^{2} & ( 12 )\end{matrix}$$

which provides an estimate of the noise correlation σ₁₂.

Turning now to FIG. 3, illustrated is a flow diagram of an embodiment of a method of crosstalk mitigation, generally designated 300, carried out in accordance with the principles of the present invention. The method 300 starts in a step 305 with intent to mitigate an initial crosstalk interference associated with a DSL system. Then in a step 310, crosstalk parameters associated with the initial crosstalk interference are determined.

These crosstalk parameters are associated with NEXT and FEXT from out-of-domain transmission lines and NEXT and FEXT from in-domain transmission lines. The crosstalk parameters are employed to train the DSL system and provide a mitigated crosstalk prior to a data transmission mode for the DSL system that is based on the crosstalk parameters, in a step 315. The step 315 provides crosstalk mitigation of several crosstalk sources and generates vectoring parameters that allow the DSL system to operate at an enhanced performance level in the data transmission mode. In an alternative embodiment, the steps 310 and 315 may be combined into a single step.

Data transmission is provided with the DSL system in the start showtime data transmission mode, in a step 320. In a first decisional step 325, a determination is made as to whether the showtime data transmission is complete. If showtime is ongoing, a determination is made in a second decisional step 330 as to whether there has been a change detected in the mitigated crosstalk since data transmission began. If the mitigated crosstalk has not changed, showtime and data transmission continue in the step 320.

If it is determined in the second decisional step 330 that the mitigated crosstalk has changed, the crosstalk parameters are updated during the showtime data transmission mode to rectify this mitigated crosstalk change, in a step 335. Optimally, the mitigated crosstalk after the change may be restored to at least the original mitigated crosstalk level thereby maintaining the data transmission mode performance of the DSL system. However, any restoration of the mitigated crosstalk change would help to maintain DSL system performance. Showtime and data transmission continue in the step 320 until it is determined in the first decisional step 325 that data transmission and therefore showtime are complete. Then the method 300 ends in a step 340.

While the method disclosed herein has been described and shown with reference to particular steps performed in a particular order, it will be understood that these steps may be combined, subdivided, or reordered to form an equivalent method without departing from the teachings of the present invention. Accordingly, unless specifically indicated herein, the order and grouping of the steps are not limitations of the present invention.

In summary, embodiments of the present invention employing a crosstalk mitigator, a method of crosstalk mitigation and a DSL system employing the mitigator or the method have been presented. These embodiments provide vectoring of the DSL system through initialization training and showtime updating. Advantages include measuring or estimating crosstalk coupling or noise correlation parameters and employing these parameters to reduce an initial crosstalk interference to a mitigated crosstalk. The mitigated crosstalk is determined during an initialization mode, which is prior to a data transmission mode of the DSL system. Since crosstalk parameters may drift over time, they may be upgraded during the showtime data transmission mode to reduce their increased impact on system performance. Signal processing techniques may be employed to mitigate a spectrum of crosstalk sources rather than having to focus on only a single crosstalk source.

Although the present invention has been described in detail, those skilled in the art should understand that they can make various changes, substitutions and alterations herein without departing from the spirit and scope of the invention in its broadest form.

1. A crosstalk mitigator for use in vectoring a digital subscriber line (DSL) system having initial crosstalk interference, comprising:
a crosstalk parameter estimation portion configured to determine crosstalk parameters associated with said initial crosstalk interference; and
a mitigator initialization portion coupled to said crosstalk parameter estimation portion and configured to train said DSL system to provide a mitigated crosstalk based on said crosstalk parameters prior to a data transmission mode.

2. The mitigator as recited in claim 1 wherein said crosstalk parameter estimation portion and said mitigator initialization portion are separate units.

3. The mitigator as recited in claim 1 wherein said crosstalk parameter estimation portion employs an orthogonal test procedure to determine said crosstalk parameters that is selected from the group consisting of:
test sequences applied during mutually exclusive time periods;
test sequences having different seeds; and
test sequences having different signatures.

4. The mitigator as recited in claim 1 wherein said mitigator initialization portion employs an initialization noise correlation crosstalk parameter associated with out-of-domain crosstalk to train said DSL system.

5. The mitigator as recited in claim 1 wherein said mitigator initialization portion employs an initialization near-end crosstalk coefficient associated with in-domain crosstalk to train said DSL system.

6. The mitigator as recited in claim 1 wherein said mitigator initialization portion employs an initialization far-end crosstalk coefficient associated with in-domain crosstalk to train said DSL system.

7. The mitigator as recited in claim 1 further comprising a showtime updating and crosstalk mitigation portion configured to detect a change in said mitigated crosstalk during said data transmission mode and update said crosstalk parameters to rectify said change in said mitigated crosstalk.

8. The mitigator as recited in claim 7 wherein said showtime updating and crosstalk mitigation portion employs at least one symbol during said data transmission mode to provide an updated far-end crosstalk coefficient for updating said crosstalk parameters.

9. The mitigator as recited in claim 7 wherein said showtime updating and crosstalk mitigation portion employs at least one symbol during said data transmission mode to provide an updated near-end crosstalk coefficient for updating said crosstalk parameters.

10. The mitigator as recited in claim 7 wherein said showtime updating and crosstalk mitigation portion employs at least one symbol during said data transmission mode to provide an updated noise correlation crosstalk parameter for updating said crosstalk parameters.

11. A method of crosstalk mitigation for use in vectoring a digital subscriber line (DSL) system having initial crosstalk interference, comprising:
determining crosstalk parameters associated with said initial crosstalk interference; and
training said DSL system to provide a mitigated crosstalk based on said crosstalk parameters prior to a data transmission mode.

12. The method as recited in claim 11 wherein said determining employs an orthogonal test procedure to determine said crosstalk parameters that is selected from the group consisting of:
test sequences applied during mutually exclusive time periods;
test sequences having different seeds; and
test sequences having different signatures.

13. The method as recited in claim 11 wherein said training employs an initialization noise correlation crosstalk parameter associated with out-of-domain crosstalk to train said DSL system.

14. The method as recited in claim 11 wherein said training employs an initialization near-end crosstalk coefficient associated with in-domain crosstalk to train said DSL system.

15. The method as recited in claim 11 wherein said training employs an initialization far-end crosstalk coefficient associated with in-domain crosstalk to train said DSL system.

16. The method as recited in claim 11 further comprising:
detecting a change in said mitigated crosstalk during said data transmission mode; and
updating said crosstalk parameters to rectify said change in said mitigated crosstalk.

17. The method as recited in claim 16 wherein at least one symbol is employed during said data transmission mode to provide an updated far-end crosstalk coefficient for updating said crosstalk parameters.

18. The method as recited in claim 16 wherein at least one symbol is employed during said data transmission mode to provide an updated near-end crosstalk coefficient for updating said crosstalk parameters.

19. The method as recited in claim 16 wherein at least one symbol is employed during said data transmission mode to provide an updated noise correlation crosstalk parameter for updating said crosstalk parameters.

20. A digital subscriber line (DSL) system, comprising:
first and second DSL transmission loops employing first and second transmission lines that experience initial crosstalk interference; and
a crosstalk mitigator, coupled to and for use in vectoring said first and second DSL transmission loops, including:
a crosstalk parameter estimation portion that determines crosstalk parameters associated with said initial crosstalk interference, and
a mitigator initialization portion, coupled to said crosstalk parameter estimation portion, that trains said DSL system to provide a mitigated crosstalk based on said crosstalk parameters prior to a data transmission mode.

21. The DSL system as recited in claim 20 wherein said crosstalk parameter estimation portion and said mitigator initialization portion are separate units.

22. The DSL system as recited in claim 20 wherein said crosstalk parameter estimation portion employs an orthogonal test procedure to determine said crosstalk parameters that is selected from the group consisting of:
test sequences applied during mutually exclusive time periods;
test sequences having different seeds; and
test sequences having different signatures.

23. The DSL system as recited in claim 20 wherein said mitigator initialization portion employs an initialization noise correlation crosstalk parameter associated with out-of-domain crosstalk to train said DSL system.

24. The DSL system as recited in claim 20 wherein said mitigator initialization portion employs an initialization near-end crosstalk coefficient associated with in-domain crosstalk to train said DSL system.

25. The DSL system as recited in claim 20 wherein said mitigator initialization portion employs an initialization far-end crosstalk coefficient associated with in-domain crosstalk to train said DSL system.

26. The DSL system as recited in claim 20 further comprising a showtime updating and crosstalk mitigation portion that detects a change in said mitigated crosstalk during said data transmission mode and updates said crosstalk parameters to rectify said increase in said mitigated crosstalk.

27. The DSL system as recited in claim 26 wherein said showtime updating and crosstalk mitigation portion employs at least one symbol during said data transmission mode to provide an updated far-end crosstalk coefficient for updating said crosstalk parameters.

28. The DSL system as recited in claim 26 wherein said showtime updating and crosstalk mitigation portion employs at least one symbol during said data transmission mode to provide an updated near-end crosstalk coefficient for updating said crosstalk parameters.

29. The DSL system as recited in claim 26 wherein said showtime updating and crosstalk mitigation portion employs at least one symbol during said data transmission mode to provide an updated noise correlation crosstalk parameter for updating said crosstalk parameters.
